(19) United States
(12) Patent Application Publication
(10) Pub. No.: US 2009/0132621 A1
(43) Pub. Date: May 21, 2009

(54) SELECTING STORAGE LOCATION FOR FILE STORAGE BASED ON STORAGE LONGEVITY AND SPEED

(76) Inventors: Craig Jensen, La Canada, CA (US); Basil Thomas, Sylmar, CA (US); Gary Quan, La Cresenta, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 12/349,457

(22) Filed: Jan. 6, 2009

Related U.S. Application Data
(63) Continuation-in-part of application No. 11/495,184, filed on Jul. 28, 2006.
(60) Provisional application No. 61/020,361, filed on Jan. 10, 2008.

(51) Int. Cl. G06F 17/30; G06F 12/02; G06F 12/00

(52) U.S. Cl. 707/205; 707/206; 707/E17.01; 707/E17.044; 711/E12.001; 711/E12.002

(57) ABSTRACT

A method for selecting storage locations is provided. The method involves selecting storage locations for file storage by matching the speed and/or longevity of the storage locations with the frequency of access of the file type of the file, or the frequency of access of the file itself. The method allows for optimized usage of storage locations by matching frequently accessed files with higher performing storage locations, storage devices or storage systems.

### CLAIM OF PRIORITY

This application claims priority under 35 U.S.C. § 119 to the U.S. Provisional Application Ser. No. 61/020,361 filed on Jan. 10, 2008. This application also claims priority as a Continuation-In-Part of application Ser. No. 11/495,184 filed on Jul. 28, 2006.

### INCORPORATION BY REFERENCE

This application hereby incorporates by reference: U.S. application Ser. No. 11/495,184 filed on Jul. 28, 2006 and U.S. Provisional Application Ser. No. 61/020,361 filed on Jan. 10, 2008.

### FIELD OF THE INVENTION

The present invention relates to selecting storage locations. More specifically, the invention relates to selecting a storage location for file storage based on storage longevity and speed.

### BACKGROUND

Modern computing systems make use of many different types of storage media devices. Storage media devices often vary in speed (e.g., read speed or write speed) and longevity (e.g., an estimated number-of-writes-before-failure or an estimated number-of-reads-before-failure). Even within a single storage system, different types of storage media or devices may vary in speed and longevity.

When requested to store a file, file systems generally use any storage locations that are available or free at time at the time of the requests. The file systems typically select from the available storage locations regardless of the types of files that are being stored. Thus, a wide variety of file types (e.g. executables, shared binaries, static data files, log files, configuration files, registry files, etc. that are used by an operating system or software application) are simply stored to storage locations that are available at the time.

However, this method of file assignment results in, for example, portions of available storage in a computing system failing long before other portions of the available storage. Furthermore, a file that is accessed infrequently may be stored in the fastest or most responsive storage locations, whereas a file that is frequently accessed may be stored in a low speed storage location.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows an exemplary system for selecting storage locations in accordance with one or more embodiments;

FIG. 2 shows a flow diagram for selecting storage locations based on a file type of the file and storage device attributes in accordance with one or more embodiments;

FIG. 3 shows a flow diagram for selecting storage locations based on a file type of the file and storage device attributes that uses temporary files in accordance with one or more embodiments;

FIG. 4 shows a flow diagram for selecting storage locations based on a file type of the file and storage device attributes using storage location mapping; and

FIG. 5 shows a block diagram of a computer system that may be used in implementing one or more embodiments.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Several features are described hereafter that can each be used independently of one another or with any combination of the other features. However, any individual feature might not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in the specification.

### OVERVIEW

A method for file positioning is provided. The method involves selecting storage locations for file storage by matching the speed and/or longevity of the storage locations with the frequency of access of a portion the file, type of the file, or the frequency of access of the file itself.

In an embodiment, file positioning involves using temporary files to fill up the available storage and selectively deleting or resizing temporary files to force file storage into the storage locations where the temporary files have been deleted or resized.

In an embodiment, file positioning involves receiving file and storage locations identified by a file system for storage of the file, and storing the file in alternate storage locations that are more suitable for storing the file.

Although specific components are recited herein as performing the method steps, in other embodiments agents or mechanisms acting on behalf of the specified components may perform the method steps. Further, although the invention is discussed with respect to components on a single system, the invention may be implemented with components distributed over multiple systems. In addition, although the invention is discussed with respect to a solid state drive (SSD), embodiments of the invention can be applicable to any storage location, storage device (e.g., a rotating disk drive, SSD, Network Attached Storage (NAS), Storage Area Network (SAN), etc.).

Embodiments of the invention also include any system that includes the means for performing the method steps described herein. Embodiments of the invention also include a computer readable medium with instructions, which when executed, cause the method steps described herein to be performed.

### SYSTEM ARCHITECTURE

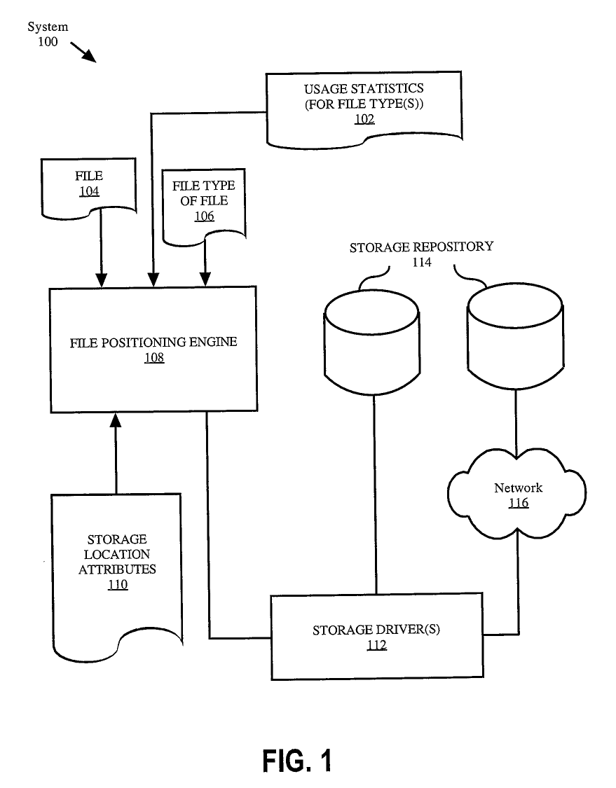

Although a specific system architecture is described herein, other embodiments of the invention are applicable to any architecture that can be used for file positioning. FIG. 1 shows an exemplary system (100) for file positioning in accordance with one or more embodiments. As shown in FIG. 1, the system (100) includes a file positioning engine (108), a storage driver(s) (112), and one or more file repositories (114). The system (100) may also include other components, which although not shown, that may be used for implementation of one or more embodiments. Each of these components may be located on the same device or may be located on separate devices coupled by a network (e.g., Internet, Intranet, Extranet, Local Area Network (LAN), Wide Area Network (WAN), etc.), with wired and/or wireless segments or on separate devices coupled in other means. In one or more embodiments of the invention, the system (100) is implemented using a client-server topology. In addition, the system may be accessible from other machines using one or more interfaces. In one or more embodiments of the invention, the system may be accessible over a network connection, such as the Internet, by one or more users. Information and/or services provided by the system may also be stored and accessed over the network connection.

### THE STORAGE REPOSITORY

The storage repository (114) generally represents one or more storage devices with storage locations where files may be stored. Portions of the storage repository (114) may be connected directly to the system (100) , may be connected over a network (116), or other suitable interfaces. The storage repository (114) may include any type of storage devices known in the art. For example, the storage repository (114) may include traditional rotating platter drives, solid state drives (SSDs), a hybrid combination of the traditional rotating platter drives and SSDs, a separate storage system like a Storage Area Network (SAN) or a Network Attached Storage (NAS) device. Furthermore, each storage device within the storage repository (114) may include different types of storage locations. For example, an SSD within the storage repository (114) may include different cells, such as, single level cells (SLCs), multi-level cells (MLCs), or a combination thereof. Thus, the storage locations within the storage repository (114) that are available for storage to the system (100) may be on a single storage device or multiple storage device with varying configurations across different storage devices or even within a single storage device.

### STORAGE LOCATION ATTRIBUTES

In an embodiment, the storage locations or data storage devices within the storage repository (114) may vary in storage location attributes (110) such as sequential write speed, sequential read speed, random write speed, random read speed, longevity, input/output operations per second (IOPS), etc. The longevity of a storage location or data storage device generally represents the estimated lifetime of the storage location or the data storage device before failure. For example, the longevity of a storage location or data storage device may be dependent on the estimated number of writes that can be performed before failure (hereinafter referred to as “number-of-writes-before-failure”) or the estimated number of reads that can be performed before failure (hereinafter referred to as “number-of-reads-before-failure”). The estimates may be specific numbers or may be virtually limitless. For example, a storage device may allow for a virtually limitless number of reads without failure. The longevity of a storage location, storage device or storage system may also be based on any other suitable factor (e.g., manufacturer, age, operating environment, etc.) Accordingly, the longetivity is not limited to any specific attribute of the storage location, storage device or storage system. Further, the storage location attributes (110) may also include the actual usage of a storage location or a storage device. The actual usage of the storage location generally represents the number of times a storage location has been accessed (e.g., the number of times the storage location has been written to or read from), the amount of time the data storage device has been in use, etc.

Information related to the storage location attributes (110) may be provided by a manufacturer. For example, the storage location attributes may (110) be provided on a compact disc (CD) sold with the storage device. The storage location attributes (110) of the storage device may also be stored onto the storage device itself, so that the storage location attributes (110) may be read from the storage device by the system (100) accessing the storage devices.

In another embodiment, tests may be performed on the storage devices or storage system to determine the attributes of the storage device or storage system. For example, a sequence of reads and/or writes may be performed on different regions of a traditional rotating platter drive to determine read or write speeds of the different regions within the rotating platter drive. Another example involves testing the read and write speeds of single level cells in a SSD and multi-level cells within the same SSD. The testing may indicate that single level cells are faster. Another example, may involve tracking the number of times a storage location or set of storage locations is accessed before failure of the storage location(s) to determine a longevity associated specifically with the storage locations or with a storage device as a whole.

### FILE TYPE INFORMATION

In an embodiment, the file (104) stored in the storage repository (114) has a file type (106). The file type (106) of the file (104) is a categorization of the file (104) that may be defined by an application, a user, or a system. For example, a file (104) created by word processing software may be of the file type “.doc”, whereas a file (104) related to an image may be of the file type “jpg”. In an embodiment, the file (104) and the file type (106) of the file (104) are received by the file positioning engine (108) from different entities.

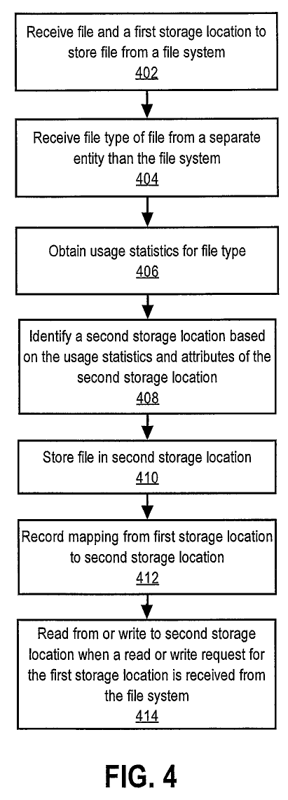

For example, an application may first provide the file (104) to a file system filter driver (not shown). A file system filter driver generally represents software and/or hardware that is implemented logically between an application and the file system. The file system filter driver may use the file positioning engine (108) to instruct the file system where to store the file. On the other hand, the file system filter driver may provide the file (104) and the instructions on where to store the file (104) directly to the file system (104) (See Storage Location Mapping discussed below with relation to FIG. 4).

### USAGE STATISTICS

Usage statistics (102) generally represent any statistics that are based on the usage of the specific file (104) being stored or based on usage of multiple files with the file type (106) of the file (104) being stored.

In an embodiment, the usage statistics (102) for a file type (106) that are received by the file positioning engine (108) may include a usage pattern such as:
the frequency of access (e.g., frequency of write access or the frequency of read access),
the timing of the usage (e.g., at startup, at shutdown, daily, weekly, immediately after creation of file, etc.),
the average lifetime for the file type (106) (e.g., short lived, long lifetime, permanent, etc.),
a priority of a process that uses the file type (106) (e.g., a user defined priority, an administrator defined priority, a priority given for a system critical process, etc.).

Usage patterns may vary from file type to file type. For example, executables, shared binaries and static file files may be rarely changed since they change when operating system or application patches are installed. Accordingly, the usage statistics (102) may indicate a low write frequency. In contrast, log files and configuration file files (e.g., operating system registry files) change very frequently. Accordingly, usage statistics (102) may indicate a high write frequency.

Another example involves media files which may be read frequently, however, generally, may not be rewritten. Furthermore, usage statistics (102) may also vary based on a type of system. For example, system boot files may be read frequently on a personal computer which is often restarted or turned on/off, whereas system boot files may be rarely read on a server as the server is rarely restarted.

The usage statistics (102) for a file type (106) may be obtained by the file positioning engine (108) from any component or may be generated by the file positioning engine (108) itself. The usage statistics (102) may be gathered by a file system or another entity and provided to the file positioning engine (108).

### FILE POSITIONING ENGINE

In an embodiment, the file positioning engine (108) within the system (100) generally represents software and/or hardware that includes logic to determine where to store the file (104) (or a portion of the file) based on the file type (106) of the file (104) and/or storage location attributes (110). The file positioning engine (108) may be configured to determine which storage device in the storage repository (114) to store the file (104) in (if more than one storage device is used). The file positioning engine (108) may also be configured to select a region or a specific storage location within the storage repository (114) to store the file (104). The file positioning engine (108) may be an application running on one or more servers, and in some embodiments could be a peer-to-peer application, or resident upon a single computing system (e.g., a personal computer, a hand-held device, a kiosk, a computer onboard a vehicle, or any other system with storage devices).

In an embodiment, the file (104) received by the file positioning engine (108) generally represents any file that is to be stored onto the storage repository (114). The file (104) may be stored onto the storage repository (114) for immediate access, future access, or even simply for backup that may or may not be accessed again.

### THE STORAGE DRIVER

In an embodiment, the storage driver(s) (112) stores and retrieves files from the storage repository (114) based on a set of instructions received directly or indirectly from the file positioning engine (108). For example, the file positioning engine (108) may provide a file (104) and a storage location for storing the file to a file system, which thereafter forwards the instructions on to the storage driver(s) (112). The instructions received by the storage(s) driver (112) may simply specify the storage device, in which case the storage driver(s) (112) determines where within the storage device to store the file. The instructions may also specify a region of storage device, a specific storage location on a storage device, a storage repository or a location in a storage repository.

### SELECTING STORAGE LOCATION BASED ON FILE TYPE AND STORAGE LOCATION ATTRIBUTES

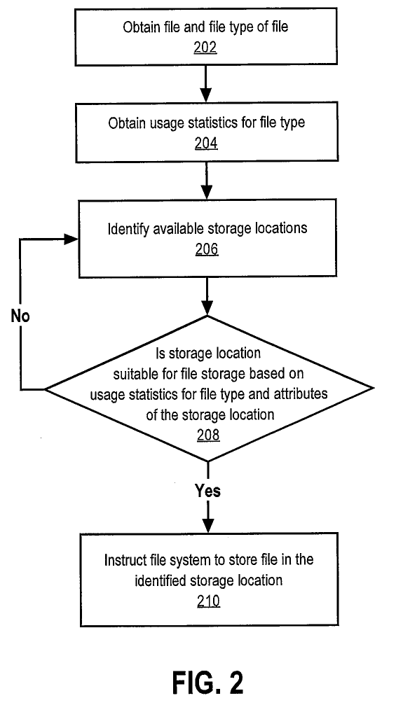

FIGS. 2-4 show flow charts for file positioning in accordance with one or more embodiments of the invention. In one or more embodiments, one or more of the steps described below may be omitted, repeated, and/or performed in a different order. Accordingly, the specific arrangement of steps shown in FIGS. 2-4 should not be construed as limiting the scope of the invention.

FIG. 2 shows a flow chart for selecting storage locations based on a file type of the file and storage location attributes. The storage locations may be selected for newly received files that have not yet been stored, or for files that have already been stored. For example, new storage locations may selected for files that have previously been stored and the files may then be moved to the newly selected storage locations. Initially, the file and the file type of the file are obtained (Step 202). The file and the file type of the file may be obtained from the same source (e.g., a software application, a file system, etc.) or from different sources. The file type of the file may be included in metafile associated with the file and received along with the file. If an unknown file type is received, the file may be categorized into a general catchall category.

In an embodiment, the usage statistics associated with the file type of the file are obtained (Step 204). The usage statistics may be obtained automatically whenever the file is received along with the file type. Alternatively, the usage statistics may be searched, based on the file type, within a local system or over a network. For example, a table containing different file types and the corresponding usage statistics may be maintained and updated periodically. In an embodiment, obtaining the usage statistics may involve using timestamps. For example, each time a file is accessed a timestamp may be logged indicating the time of access and the type of access. The timestamps may then be used to calculate the frequency of access for each type of access. Thereafter, the frequency of access for multiple files of the same type may be combined in some manner (e.g., average, mode, median, etc. of the frequency of access) to obtain usage statistics associated with the file type.

In an embodiment, a storage location that is available for allocation is identified (Step 206) until a storage location that is suitable for file storage is found based on the usage statistics for the file type and attributes of the storage location (Step 208). In order to find suitable a storage location, the usage statistics for the file type are matched with the attributes of the storage location. For example, a high level of usage is matched with a storage location that allows for high speed read/write access and/or a large number of reads/writes before failure. A low level of usage is matched with a storage location that allows for lower speed read/write access and/or a low number for reads/writes before failure. In an embodiment, the matching is based on comparison of all available storage locations to usage statistics across many different file types. For example, of the available storage locations, the top quartile of fastest or longest lasting storage locations is matched with the top quartile of files that are used most frequently.

Another example involves the use of traditional platter drives and solid state drives. Traditional platter drives generally tend to have a very high longevity or estimated lifetime, which is defined as allowing a high number of reads or writes before failure. Traditional platter drives, however, tend to be slow. In comparison, solid state drives generally have a low longevity (generally 5,000 to 100,000 read/write cycles before failure), but offer higher read/write speeds. Accordingly, if for example, an operating system continually logs (e.g., every second) user activity using a background process where the write speed is not important, then traditional platter drives may be more suitable as the traditional platter drive would allow for a very large number of writes without failure. A solid state drive may not suitable in this example as the solid state drive is more likely to fail with continual writing.

A third example involves an application which requires a large number of random access reads. A traditional platter drive has a slower random access read time in comparison to a solid state drive because the traditional platter drive is limited by the rotation speed of the platter (generally between 5,400 rpm and 15,000 rpm) and the movement of the head over the platter. In contrast, a solid state drive does not have any platters, heads, or other moving parts that may greatly impact the speed of a random access read. In this case, a solid state drive may be better to store the file if the random access read speed is important.

In an embodiment, the timing of file access may be used to determine a suitable storage location. For example, in some cases temporary internet files created by a browser application or a user downloaded executable file may be used immediately following creation of the files and thereafter used rarely. Furthermore, the same user may tend to download media files into a large library of media files for rare use. In this example, the temporary internet files created by the browser application or the user downloaded executable files may be matched with high speed storage locations in view of the expected use based on the user's habits. Additionally, the media files that are downloaded into a large library of rarely used media files may be matched with slower speed storage locations. In an embodiment, files may periodically be transferred from fast performing storage locations to slow performing storage locations. In the example, the temporary internet files created by the browser may be moved to slower performing storage locations after a day or a week from creation as the usage level is expected to be lower over time. The predetermined time for such automated transfer from high performing storage locations to slow performing storage locations may be configured by a user, an administrator, a manufacturer, or may be determined based on the particular usage habits of a user.

In an embodiment, the match between the usage statistics of file types and the attributes of the storage location take into account the operating environment or system. For example, access to different file types may vary in a laptop, a server, a hand-held device, a kiosk at an airport, etc. Boot up files on an airport kiosk may be stored on slow performing storage locations as the airport kiosk may rarely be re-booted, whereas boot up files on a laptop may be frequently accessed and accordingly stored in fast performing storage locations. Furthermore, the speed of booting up an airport kiosk may be not important to a user whereas the speed of booting up a laptop may be very important to a user.

Although the examples provided above are described with respect to the usage statistics of the file type of the file, each of the above examples are also applicable for storage location matching based on usage statistics of a specific file. For example, a computer system that controls elevator music in a building may contain a multitude of audio files that are rarely used and a minute long audio clip is continuously read and played in the building elevators. In this case, when an audio file is received, the computer system may store the audio file anywhere, however the computer system may maintain the minute long audio clip in a storage location with a high longevity to allow for the continuous read access without failure. Furthermore, when a user switches the audio file being played in the elevators the system may transfer the new audio file being played continuously to the storage location with the high read longevity. Accordingly, in an embodiment, the file positioning is based on the frequency of accessing the actual file and the longevity of the storage location.

Once a suitable storage location for storage of the file is identified, the file system is instructed to store the file in the identified storage location in accordance with one or more embodiments (Step 210). In response to the instructions, the file system provides the file and instructions to a corresponding storage driver(s) for storage of the file.

### SELECTING STORAGE LOCATIONS USING TEMPORARY FILES

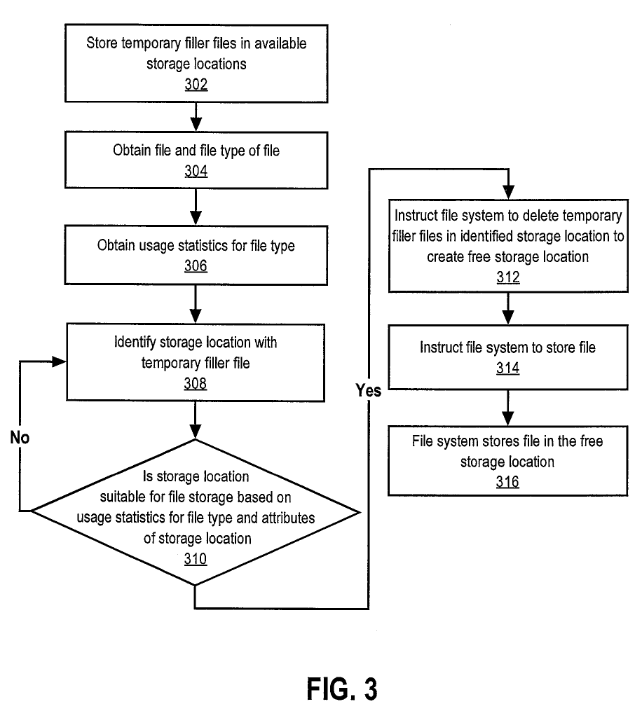

FIG. 3 shows a flow chart for selecting storage locations based on a file type of the file and storage device attributes that uses temporary files in accordance with one or more embodiments. This method for storage location selection involves using temporary files to fill up the available storage and selectively deleting temporary files to force file storage into the storage locations where the temporary files have been deleted.

Initially, temporary filler files are stored in available storage locations in accordance with one or more embodiments (Step 302). The available storage locations may be partitioned into multiple regions of any size, where a temporary filler file is stored in each of the regions. The size of the regions may be, for example, the average size of a file stored in storage devices or any variation thereof. Further, each of the regions may even be of different sizes. In an embodiment, storage locations are partitioned into regions such that storage locations within the same region have the same speed and/or longevity.

In an embodiment, the file and the file type of the file is obtained (Step 304) in essentially the same manner as described above with reference to Step 202. Furthermore usage statistics are obtained for the file type (Step 306) in essentially the same manner as described above with reference to Step 204. In an embodiment, a storage location with temporary filler files is identified (Step 308) until a storage location that is suitable for file storage is found based on the usage statistics for the file type and attributes of the storage location (Step 310). Exemplary steps for determining whether the storage location is suitable for file storage is described above with respect to Step 206 and Step 208.

Once the storage location is identified, the file system is given instructions to delete or resize the temporary filler files in the identified storage location in accordance with one or more embodiments (Step 312). For example, if storage locations within a region are identified for file storage, all the temporary file(s) within the region containing the identified storage locations may be deleted or resized to a smaller size; or only the temporary file at the identified storage location may be deleted or resized to a smaller size. Deleting or resizing the temporary filler files results in the file system acknowledging that the identified storage locations are in fact available for allocation. Furthermore, as the remainder of the available storage locations are occupied with temporary filler files, the file system determines that the identified storage locations are the only storage locations that are free for allocation. Accordingly, when the file system is subsequently instructed to store the file (Step 314), the file system stores the file in the identified storage locations (Step 316).

### SELECTING STORAGE LOCATIONS USING STORAGE LOCATION MAPPING

FIG. 4 shows a flow diagram for selecting storage locations based on the file type of the file and storage device attributes using storage location mapping. In an embodiment, storage location selection is performed by intercepting instructions from a file system to a storage driver, modifying the instructions, and providing the modified instructions to the storage driver. Alternatively, the steps described below may be performed by the storage driver. Instructions from the file system, which include data (e.g., a file) and a first storage location(s) selected by the file system to store the file, are received by an entity (e.g., software and/or hardware module) that is logically located between the file system and storage driver(s) (Step 402). In an embodiment, this entity may be a part of the storage driver itself. The file type of the file may be received from an alternate source (e.g., a file system filter driver) than the file system itself (Step 404). Subsequently, the usage statistics associated with the file type of the file are obtained (Step 406). Thereafter, a second storage location(s) is identified for storage of the file that is more suitable than the first storage location selected by the file system based on the usage statistics associated with the file type and the attributes of the second storage location, as described above with relation to FIG. 2 (Step 208). Instructions are then sent to the storage driver(s) to store the file in the second storage location (Step 410). Accordingly, in one or more embodiments, a storage location selected by the file system is replaced by another storage location for storage of the file. Furthermore, a mapping of the first storage location to the second storage location is recorded indicating that the file that is supposed to be in the first storage location is in fact in a second storage location (Step 412). Each time thereafter when a file system requests access (read or write) to the file, the file system actually requests that the file be read from or written to the first storage location. However, this access instruction is also intercepted and based on the previously recorded mapping, the file is written to or read from the second storage location (Step 414). Accordingly, in an embodiment, the file system is unaware of the actual positioning of the file. The actual positioning is handled below the file system level.

### SELECTING STORAGE LOCATIONS BASED ON USAGE OF THE ESTIMATED LIFETIME OF STORAGE LOCATIONS

In one or more embodiments, storage location selection is based on the relative usage of the estimated lifetime of the different storage locations or data storage devices. As discussed above in the “Storage Location Attributes” section, the longevity or the estimated lifetime may vary from one data storage device to another data storage device. The longevity or the estimated lifetime may even vary between different storage regions within the same data storage device. For example, the number-of-writes-before-failure or the number-of-reads-before-failure may differ for a solid state drive and a traditional rotating platter drive. The usage is a percentage determined by dividing the actual usage by the estimated lifetime. For example, the usage percentage for writes may be determined by dividing the actual number of writes to a storage location by the number-of-writes-before-failure. The relative usage percentage of a storage location is the usage percentage of the storage location in comparison with the usage percentage of other storage locations.

In an embodiment, the storage location is selected for allocation such that the usage percentage across the different storage regions is approximately balanced. For example, if a first storage region has a number-of-writes-before-failure of 100,000 writes and an actual usage of 50,000 writes then the usage percentage for the first storage region is 50%. Further, if a second storage region has a number-of-writes-before-failure of 5,000 writes and an actual usage of 2,000 writes then the usage percentage of the second storage region is 40%. In this example involving the first storage region and the second storage region, the relative usage percentage of the second storage region is lowest. Accordingly, the second storage region would be allocated for file storage request until at least 2,500 writes of the estimated 5,000 number-of-writes-before-failure have been completed when the second storage region reaches a usage percentage of 50%. In this manner the usage percentages across different storage regions are kept approximately equal so that any one particular storage region does not fail much earlier than the other storage regions.

### HARDWARE OVERVIEW

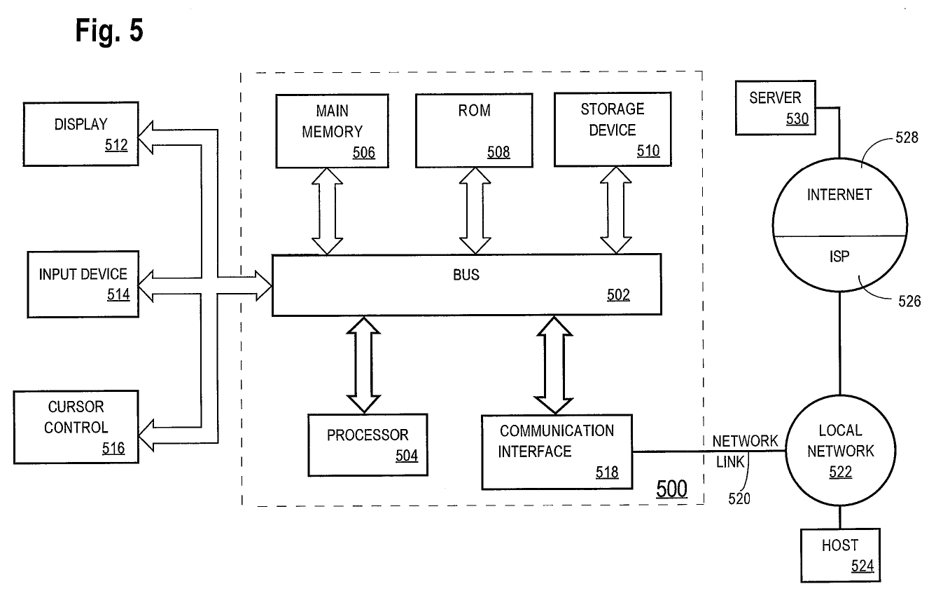

FIG. 5 is a block diagram that illustrates a computer system 500 upon which an embodiment of the invention may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

The invention is related to the use of computer system 500 for implementing the techniques described herein. According to one embodiment of the invention, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operate in a specific fashion. In an embodiment implemented using computer system 500, various machine-readable media are involved, for example, in providing instructions to processor 504 for execution. Such a medium may take many forms, including but not limited to storage media and transmission media. Storage media includes both non-volatile media and volatile media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502. Transmission media can also take the form of acoustic or light waves, such as those generated during radio-wave and infra-red file communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 504 for execution. For example, the instructions may initially be carried on a magnetic disk of a remote computer. The remote computer can load the instructions into its dynamic memory and send the instructions over a telephone line using a modem. A modem local to computer system 500 can receive the file on the telephone line and use an infra-red transmitter to convert the file to an infra-red signal. An infra-red detector can receive the file carried in the infra-red signal and appropriate circuitry can place the file on bus 502. Bus 502 carries the file to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way file communication coupling to a network link 520 that is connected to a local network 522. For example, communication interface 518 may be an integrated services digital network (ISDN) card or a modem to provide a file communication connection to a corresponding type of telephone line. As another example, communication interface 518 may be a local area network (LAN) card to provide a file communication connection to a compatible LAN. Wireless links may also be implemented. In any such implementation, communication interface 518 sends and receives electrical, electromagnetic or optical signals that carry digital file streams representing various types of information.

Network link 520 typically provides file communication through one or more networks to other file devices. For example, network link 520 may provide a connection through local network 522 to a host computer 524 or to file equipment operated by an Internet Service Provider (ISP) 526. ISP 526 in turn provides file communication services through the world wide packet file communication network now commonly referred to as the “Internet” 528. Local network 522 and Internet 528 both use electrical, electromagnetic or optical signals that carry digital file streams. The signals through the various networks and the signals on network link 520 and through communication interface 518, which carry the digital file to and from computer system 500, are exemplary forms of carrier waves transporting the information.

Computer system 500 can send messages and receive file, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution. In this manner, computer system 500 may obtain application code in the form of a carrier wave.

### EXTENSIONS AND ALTERNATIVES

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A computer-implemented method comprising:
obtaining attributes for each of a plurality of storage locations;
obtaining a file and a file type of the file;
obtaining at least one usage statistic associated with the file type, wherein the at least one usage statistic was generated by monitoring usage of files having said file type;
selecting a first storage location of the plurality of storage locations to store the file based on the attributes of the first storage location and the at least one usage statistic associated with the file type of the file; and
causing the file to be stored to the first storage location.

2. The method of claim 1, further comprising:
responsive to termination of a predetermined time period, transferring the file from the first storage location to a second storage location,
wherein the second storage location has a lower performance than the first storage location.

3. The method of claim 1, further comprising:
storing a temporary filler file in each of the plurality of storage locations;
wherein causing the file to be stored to the first storage location comprises:
deleting or resizing the temporary filler file in the first storage location to free the first storage location for storage of the file.

4. The method of claim 1, wherein causing the file to be stored to the first storage location comprises:
receiving instructions from a file system to store the file to a second storage location;
determining that the first storage location is a more suitable location to store the file than the second storage location; and
instructing a storage driver to store the file in the first storage location instead of the second storage location.

5. The method of claim 4, further comprising:
recording that the file intended to be stored in the second storage location is stored in the first storage location.

6. The method of claim 5, further comprising:
receiving a request from the file system to retrieve the file from the second storage location; and
responsive to the request from the file system, retrieving the file from the first storage location.

7. The method of claim 1, further comprising:
wherein the file is obtained from a file system; and
wherein the file type of the file is obtained from a file system filter driver.

8. The method of claim 1, wherein the at least one usage statistic is a write frequency associated with the file type.

9. The method of claim 1, wherein the at least one usage statistic is a read frequency associated with the file type.

10. The method of claim 1, wherein selecting the first storage location based on the attributes of the first storage location comprises selecting the first storage location based on a write speed associated with the first storage location.

11. The method of claim 1, wherein selecting the first storage location based on the attributes of the first storage location comprises selecting the first storage location based on a read speed associated with the first storage location.

12. The method of claim 1, wherein selecting the first storage location based on the attributes of the first storage location comprises selecting the first storage location based on a number-of-writes-before-failure associated with the first storage location.

13. The method of claim 1, wherein selecting the first storage location based on the attributes of the first storage location comprises selecting the first storage location based on a number-of-reads-before-failure associated with the first storage location.

14. The method of claim 1, wherein selecting the first storage location based on the attributes of the first storage location comprises selecting the first storage location based on a number of input/output operations that can be performed per second (IOPS) at the first storage location.

15. The method of claim 1, wherein the plurality of storage locations are comprised in one or more secondary storage devices separate from a central processing unit.

16. The method of claim 1, wherein selecting a first storage location of the plurality of storage locations to store the file is further based on a relative usage percentage of each of the plurality of storage locations.

17. The method of claim 1, wherein causing the file to be stored to the first storage location comprises transferring the file from a second storage location where the file was originally stored.

18. A computer-implemented method comprising:
obtaining longevity information for each of a plurality of storage locations;
obtaining a file and a frequency of access of the file;
selecting a first storage location of the plurality of storage locations to store the file based on the longevity of the first storage location and the frequency of access of the file; and
causing the file to be stored to the first storage location.

19. The method of claim 18, wherein the first storage location has a relatively higher longevity than the second storage location.

20. The method of claim 18, wherein causing the file to be stored to the first storage location comprises:
receiving instructions from a file system to store the file to a second storage location;
determining that the first storage location is a more suitable location to store the file than the second storage location; and
instructing a storage driver to store the file in the first storage location instead of the second storage location.

21. The method of claim 18, further comprising:
storing a temporary filler file in each of the plurality of storage locations;
wherein causing the file to be stored to the first storage location comprises:
deleting or resizing the temporary filler file in the first storage location to free the first storage location for storage of the file.

22. A computer-implemented method comprising:
storing a temporary filler file in each of the plurality of storage locations;
selecting a storage location of the plurality of storage locations to store a file;
causing the file to be stored in the storage location of the plurality of storage locations by:
deleting or resizing the temporary filler file from the storage location of the plurality of storage locations; and
subsequently requesting storage of the file.

23. A computer-implemented method comprising:
receiving instructions from a file system to store the file to a first storage location;
determining that a second storage location is a more suitable location to store the file than the second storage location;
instructing a storage driver to store the file in the second storage location instead of the first storage location;
recording that the file intended to be stored in the first storage location is stored in the second storage location;
receiving a request from the file system to retrieve the file from the first storage location; and
responsive to the request from the file system to retrieve the file from the first storage location, retrieving the file from the second storage location.

24. A computer readable storage medium comprising one or more sequences of instructions, which when executed by one or more processors cause:
obtaining attributes for each of a plurality of storage locations;
obtaining a file and a file type of the file;
obtaining at least one usage statistic associated with the file type, wherein the at least one usage statistic was generated by monitoring usage of files having said file type;
selecting a first storage location of the plurality of storage locations to store the file based on the attributes of the first storage location and the at least one usage statistic associated with the file type of the file; and
causing the file to be stored to the first storage location.

25. The computer readable storage medium of claim 24, wherein the one or more sequences executed by the one or more processors further cause:
responsive to termination of a predetermined time period, transferring the file from the first storage location to a second storage location,
wherein the second storage location has a lower performance than the first storage location.

26. The computer readable storage medium of claim 24, wherein the one or more sequences executed by the one or more processors further cause:
storing a temporary filler file in each of the plurality of storage locations;
wherein causing the file to be stored to the first storage location comprises:
deleting or resizing the temporary filler file in the first storage location to free the first storage location for storage of the file.

27. The computer readable storage medium of claim 24, wherein causing the file to be stored to the first storage location comprises:
receiving instructions from a file system to store the file to a second storage location;
determining that the first storage location is a more suitable location to store the file than the second storage location; and
instructing a storage driver to store the file in the first storage location instead of the second storage location.

28. The computer readable storage medium of claim 27, wherein the one or more sequences executed by the one or more processors further cause:
recording that the file intended to be stored in the second storage location is stored in the first storage location.

29. The computer readable storage medium of claim 28, wherein the one or more sequences executed by the one or more processors further cause:
receiving a request from the file system to retrieve the file from the second storage location; and
responsive to the request from the file system, retrieving the file from the first storage location.

30. The computer readable storage medium of claim 24, wherein the one or more sequences executed by the one or more processors further cause:
wherein the file is obtained from a file system; and
wherein the file type of the file is obtained from a file system filter driver.

31. The computer readable storage medium of claim 24, wherein the at least one usage statistic is a write frequency associated with the file type.

32. The computer readable storage medium of claim 24, wherein the at least one usage statistic is a read frequency associated with the file type.

33. The computer readable storage medium of claim 24, wherein selecting the first storage location based on the attributes of the first storage location comprises selecting the first storage location based on a write speed associated with the first storage location.

34. The computer readable storage medium of claim 24, wherein selecting the first storage location based on the attributes of the first storage location comprises selecting the first storage location based on a read speed associated with the first storage location.

35. The computer readable storage medium of claim 24, wherein selecting the first storage location based on the attributes of the first storage location comprises selecting the first storage location based on a number-of-writes-before-failure associated with the first storage location.

36. The computer readable storage medium of claim 24, wherein selecting the first storage location based on the attributes of the first storage location comprises selecting the first storage location based on a number-of-reads-before-failure associated with the first storage location.

37. The computer readable storage medium of claim 24, wherein selecting the first storage location based on the attributes of the first storage location comprises selecting the first storage location based on a number of input/output operations that can be performed per second (IOPS) at the first storage location.

38. The computer readable storage medium of claim 24, wherein the plurality of storage locations are comprised in one or more secondary storage devices separate from a central processing unit.

39. The computer readable storage medium of claim 24, wherein selecting a first storage location of the plurality of storage locations to store the file is further based on a relative usage percentage of each of the plurality of storage locations.

40. The computer readable storage medium of claim 24, wherein causing the file to be stored to the first storage location comprises transferring the file from a second storage location where the file was originally stored.

41. A computer readable storage medium comprising one or more sequences of instructions, which when executed by one or more processors cause:
obtaining longevity information for each of a plurality of storage locations;
obtaining a file and a frequency of access of the file;
selecting a first storage location of the plurality of storage locations to store the file based on the longevity of the first storage location and the frequency of access of the file; and
causing the file to be stored to the first storage location.

42. The computer readable storage medium of claim 41, wherein the first storage location is within a rotating platter drive and a second storage location that was not selected for storage of the file is within a solid state drive, wherein the rotating platter drive has a relatively higher longetivity than the solid state drive.

43. The computer readable storage medium of claim 41, wherein causing the file to be stored to the first storage location comprises:
receiving instructions from a file system to store the file to a second storage location;
determining that the first storage location is a more suitable location to store the file than the second storage location; and
instructing a storage driver to store the file in the first storage location instead of the second storage location.

44. The computer readable storage medium of claim 41, wherein the one or more sequences executed by the one or more processors further cause:
storing a temporary filler file in each of the plurality of storage locations;
wherein causing the file to be stored to the first storage location comprises:
deleting or resizing the temporary filler file in the first storage location to free the first storage location for storage of the file.

45. A computer readable storage medium comprising one or more sequences of instructions, which when executed by one or more processors cause:
storing a temporary filler file in each of the plurality of storage locations;
selecting a storage location of the plurality of storage locations to store a file;
causing the file to be stored in the storage location of the plurality of storage locations by:
deleting or resizing the temporary filler file from the storage location of the plurality of storage locations; and
subsequently requesting storage of the file.

46. A computer readable storage medium comprising one or more sequences of instructions, which when executed by one or more processors cause:
receiving instructions from a file system to store the file to a first storage location;
determining that a second storage location is a more suitable location to store the file than the first storage location;
instructing a storage driver to store the file in the second storage location instead of the first storage location;
recording that the file intended to be stored in the first storage location is stored in the second storage location;
receiving a request from the file system to retrieve the file from the first storage location; and
responsive to the request from the file system to retrieve the file from the first storage location, retrieving the file from the second storage location.
